(19) United States
(12) Patent Application Publication
(10) Pub. No.: US 2008/0273102 A1
(43) Pub. Date: Nov. 6, 2008

(54) DETECTION DEVICE FOR DEFECTIVE PIXEL IN PHOTOGRAPHIC DEVICE

(75) Inventors: Kaoru HYAKUTAKE, Kanagawa (JP); Takaaki SHOJI, Saitama (JP); Machiko AZUMA, Saitama (JP); Shinichi TAKAYAMA, Tokyo (JP)

Correspondence Address: GREENBLUM & BERNSTEIN, P.L.C., 1950 ROLAND CLARKE PLACE, RESTON, VA, 20191, US

(73) Assignee: HOYA CORPORATION, Tokyo (JP)

(21) Appl. No.: 12/112,188

(22) Filed: Apr. 30, 2008

(30) Foreign Application Priority Data
May 1, 2007 (JP) 2007-120576

(51) Int. Cl. H04N 9/64

(52) U.S. Cl. 348/246; 348/E09.037

(57) ABSTRACT

The defeat determination unit determines whether a target pixel among the pixels of the image sensor is defective on the basis of a first defect map and at least one second defect map. The first defeat map shows a first relationship between a pixel value of the target pixel and pixel values of first neighboring same-color pixels with the target pixel that neighbor and surround the target pixel. The second defect map shows a second relationship between a pixel value of a heterochromatic adjacent pixel with the target pixel and pixel values of second neighboring same-color pixels with the heterochromatic adjacent pixel that neighbor and surround the heterochromatic adjacent pixel.

### BACKGROUND OF THE INVENTION

1. Field of the Invention

The present invention relates to a photographic device that detects a defective pixel in an image sensor.

2. Description of the Related Art

A defect correction device that determines whether a target pixel in an image sensor is defective, on the basis of the target pixel and the pixel adjacent to the target pixel is proposed.

Japanese unexamined patent publication (KOKAI) No. 2002-10274 discloses a defect correction device that determines whether a target pixel in an image sensor is defective on the basis of the complementary color signals of the pixel data that give the pixel values for cyan etc.

However, in this defect correction device, it is necessary to generate a complementary color signal, thus making the image processing circuit complicate.

### SUMMARY OF THE INVENTION

Therefore, an object of the present invention is to provide a photographic device that detects a defective pixel in an image sensor without complicating the circuit construction.

According to the present invention, a photographic device comprises an image sensor and a defect determination unit.

The defect determination unit determines whether a target pixel among the pixels of the image sensor is defective on the basic of a first defect map and at least one second defect map. The first defect map shows a first relationship between a pixel value of the target pixel and pixel values of first neighboring same-color pixels with the target pixel that neighbor and surround the target pixel. The second defect map shows a second relationship between a pixel value of a heterochromatic adjacent pixel with the target pixel and pixel values of second neighboring; same-color pixels with the heterochromatic adjacent pixel that neighbor and surround the heterochromatic adjacent pixel.

### BRIEF DESCRIPTION OF THE DRAWINGS

The objects and advantages of the present invention will be better understood from the following description, with reference to the accompanying drawings in which:

FIG. 1 is a construction diagram of the photographic device in the embodiment;

FIG. 2 is a construction diagram of the image-processing unit;

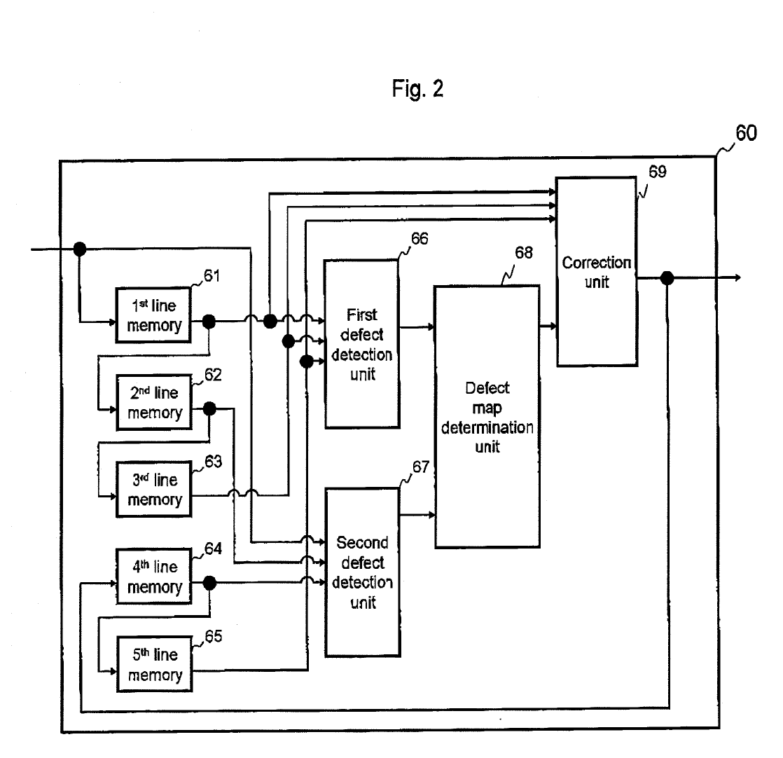

FIG. 3 is a construction diagram of pixels of the image sensor;

FIG. 4 gives examples of defect maps showing the magnitude relationship between the threshold and the differences between the pixel value of the target pixel and the pixel values of the neighboring same-color pixels;

FIG. 5 is a defect map that shows the magnitude relationship between the threshold and the differences between the pixel value of the target pixel and the pixel values of the neighboring same-color pixels with the target pixel, and the magnitude relationship between the threshold and the differences between the pixel value of the adjacent pixel and the pixel values of the neighboring same-color pixels with the adjacent pixel, in the case that the target pixel is not defective;

FIG. 6 is a defect map that shows the magnitude relationship between the threshold and the differences between the pixel value of the target pixel and the pixel values of the neighboring same-color pixels with the target pixel, and the magnitude relationship between the threshold and the differences between the pixel value of the adjacent pixel and the pixel values of the neighboring same-color pixels with the adjacent pixel, in the case that the target pixel is the line-defective pixel;

FIG. 7 is a defect map that shows the magnitude relationship between the threshold and the differences between the pixel value of the target pixel and the pixel values of the neighboring same-color pixels with the target pixel, and the magnitude relationship between the threshold and the differences between the pixel value of the adjacent pixel and the pixel values of the neighboring same-color pixels with the adjacent pixel, in the case that the target pixel is the point-defective pixel;

FIG. 8 is a flowchart showing the process of the determining whether a target pixel is defective; and

FIG. 9 is a construction diagram of pixels in the image sensor in which the last reading line has changed from the state in FIG. 3.

### DESCRIPTION OF THE PREFERRED EMBODIMENTS

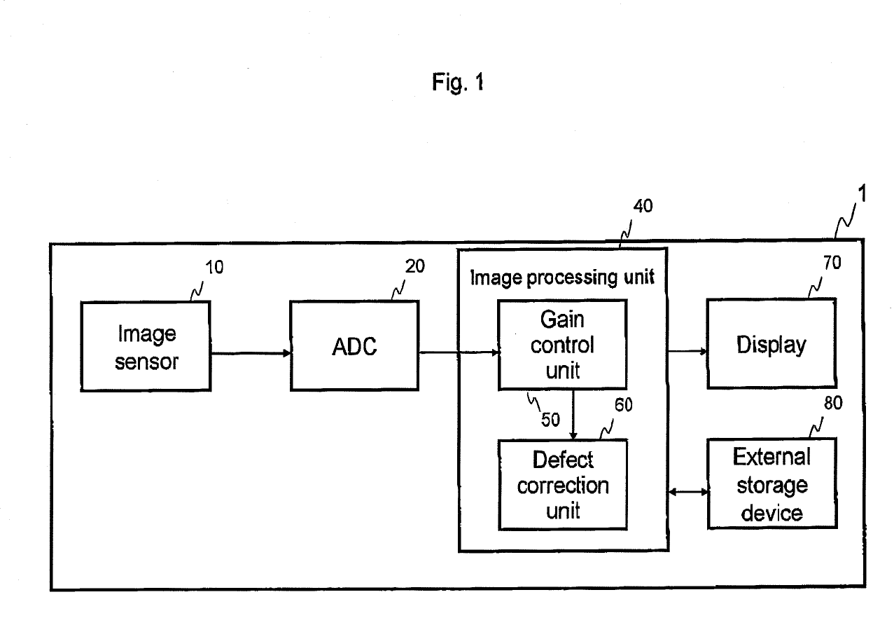

The present invention is described below with reference to the embodiment shown in the drawings. In the embodiment, the photographic device 1 is a digital camera with an image sensor 10, an ADC (Analog Digital Converter) 20, a controller 30, an image-processing unit 40, a display 70, and an external storage device 80 (see FIG. 1).

The image sensor 10 performs a photoelectric conversion by converting light forming the photographic image into an analog signal. The analog signal is then converted to a digital signal by the ADC 20.

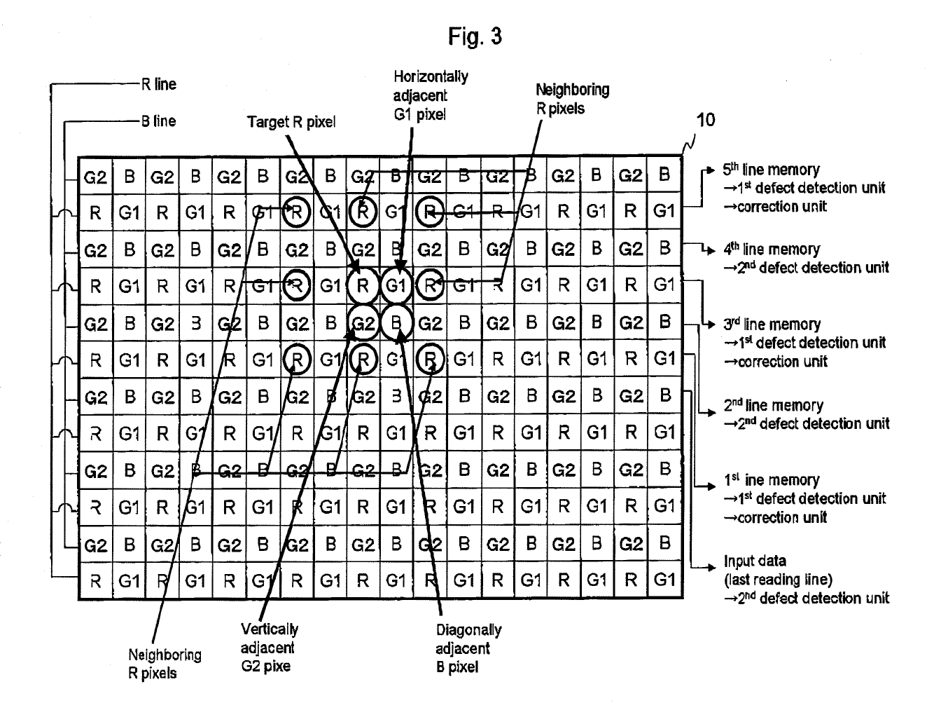

In the embodiment, a Bayer color filter array is arranged over the pixels of the image sensor 10. The Bayer filter of the image sensor 10 has R lines and B lines (see FIG. 3). The R lines include red filters and first green filters. The B lines include blue filters and second green filters. The R lines and the B lines are arranged alternately. The red filters and the first green filters are arranged alternately on the R line. The blue filters and the second green filters are arranged alternately on the B line.

In the embodiment, a pixel corresponding to the red filter is defined as an R pixel, a pixel corresponding to the first green filter is defined as a G1 pixel, a pixel corresponding to the blue filter is defined as a B pixel, and a pixel corresponding to the second green filter is defined as a G2 pixel.

However, the arrangement of the color filter over the pixels of the image sensor 10 is not limited, to the Bayer color filter array.

Furthermore, the colors of the color filter are not limited to the red, green, and blue. For example, the cyan, magenta, and yellow may be used for the colors of the color filter.

The pixel data consisting of the digital signal converted by the ADC 20 is input to the image-processing unit 40. The image-processing unit 40 is a DSP or the like, and has a gain control unit 50 and a defect correction unit 60. Gain control of the pixel data is performed for every color at the gain control unit 50, and then gain-controlled, pixel data is input to the defect correction unit 60.

The defect correction unit 60 has a first line memory 61, a second line memory 62, a third line memory 63, a fourth line memory 64, a fifth line memory 65, a first defect detection unit 66, a second defect detection unit 67, a defect map determination unit 68, and a correction unit 69.

The data of the last reading line in the gain-controlled pixel data that is input to the image-processing unit 40, is input to the second defect detection unit 67. The last reading line is the line of pixels arranged on the image sensor 10 that has just been read out.

The data of the second-to-last reading line in the gain-controlled pixel data is input to the first line memory 61. The second-to-last reading line, which is defined as the first line, is the reading line above the last reading line on the image sensor 10 and is read out before the reading out of the last reading line.

The data of the third-to-last reading line in the gain-controlled pixel data is input to the second line memory 62. The third-to-last reading line, which is defined as the second line, is the reading line above the first line on the image sensor 10 and is read out before the reading out of the first line.

The data of the fourth-to-last reading line in the gain-controlled pixel data is input to the third line memory 63. The fourth-to-last reading line, which is defined as the third line, is the reading line above the second line on the image sensor 10 and that is read out before the reading out of the second line.

The data of the fifth-to-last reading line in the gain-controlled pixel data is input to the fourth line memory 64 after the defect correction by the correction unit 69. The fifth-to-last reading line, which is defined as the fourth line, is the reading line above the third line on the image sensor 10 and is read out before the reading out of the third line.

The data of the sixth-to-last reading line in the gain-controlled pixel data is input to the fifth line memory 65 after the defect correction by the correction unit 69. The sixth-to-last reading line, which is defined as the fifth line, is the reading line above the fourth line on the image sensor 10 and is read out before the reading out of the fourth line.

The first defect detection unit 66 calculates a first defect map for the target pixel on the third line, on the basis of the pixel data for the first line, the third line, and the fifth line.

The first defect detection unit 66 also calculates a second defect; map for a heterochromatic adjacent, pixel on the third line horizontally adjacent to the target pixel, on the basis of the pixel data for the first line, the third line, and the fifth line.

The second defect detection unit 67 calculates a third defect map for a heterochromatic adjacent pixel on the second line vertically adjacent to the target pixel, on the basis of the pixel data for the last reading line, the second line, and the fourth line.

The second defect detection unit 67 also calculates a fourth defect map for a heterochromatic adjacent pixel on the second line diagonally adjacent to the target pixel, on the basis of the pixel data for the last reading line, the second line, and the fourth line.

In the embodiment, the G1 pixel and the G2 pixel are defined as heterochromatic pixels, although the filter over the G1 pixel and the filter over the G2 pixel have same green color filters.

Any pixel is not arranged between the heterochromatic adjacent pixel and the target pixel. The color of the filter over the heterochromatic adjacent pixel and the color of the filter over the target pixel axe different.

All pixels of the third line sequentially become the target pixel in the process of defect detection and correction.

After all of the pixels of the third line have been become the target pixel, the pixel data stored in the first, second, third, and fourth line memories 61, 62, 63, and 64 and the data input to the second defect detection unit 67, are transferred to the next-numbered line memory.

Note that, the pixel data for the fifth line stored in the fifth line memory 65 is deleted.

The pixel data for the fourth line stored in the fourth line memory 64 is transferred to the fifth line memory 65 to become the pixel data for the fifth line.

The pixel data for the third line stored in the third line memory 63 is transferred to the fourth line memory 64 to become the pixel data for the fourth line, through the correction unit 69.

The pixel data for the second line stored in the second line memory 62 is transferred to the third line memory 63 to become the pixel data for the third line.

The pixel data for the first line stored in the first line memory 61 is transferred to the second line memory 62 to become the pixel data for the second line.

The pixel data for the last reading line input to the second defect detection unit 67 is transferred to the first line memory 61 to become the pixel data for the first line.

Thereby, all pixels on the image sensor 10 undergo defect detection and correction in series.

Next, the details of the calculation of the first, second, third, and fourth defect maps are explained. The example illustrates the case in which the pixel data of the R and G1 pixels is included in the third line and the pixel data of the G2 and B pixels is included in the second line. One of the R pixels corresponding to the pixel data of the third line is set to be the target pixel, so that the adjacent G1 pixel to the right side of the target R pixel, the adjacent B pixel to the lower-right side of the target R pixel, and the adjacent G2 pixel to the lower side of the target R pixel, are designated the heterochromatic adjacent pixels (see FIG. 3).

Likewise, a G1 pixel on the third line can be set to be the target pixel.

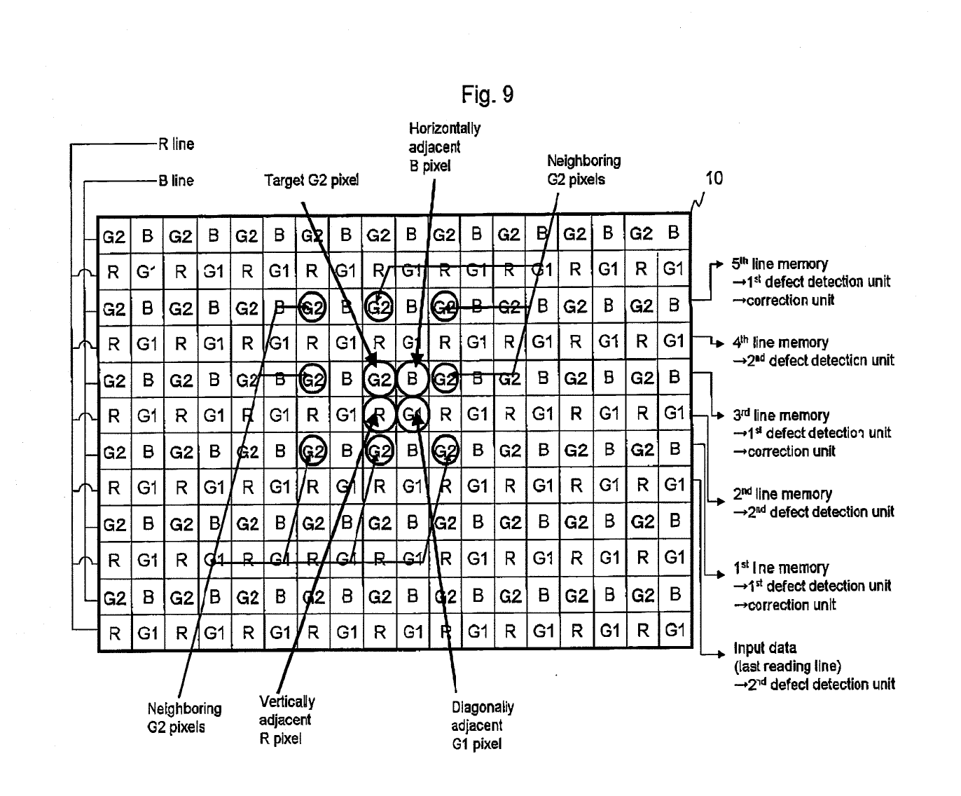

Furthermore, after the pixel data stored in the current line memory is transferred to the next line memory, either a G2 pixel or a B pixel on the third line can be set to be the target pixel (see FIG. 9).

The first defect detection unit 66 calculates eight differences between the pixel value of the target R pixel and the pixel values of the eight neighboring R pixels that neighbor and surround the target R pixel. The pixel value is the value of the pixel data output from the pixel based on the imaging operation by the image sensor 10.

Then, the first defect detection unit 66 determines whether each of the eight differences relative to the target R pixel exceeds a threshold and specifies a defect map of the magnitude relationship between the eight differences and the threshold.

In other words, the first defect detection unit 66 creates the defect map of magnitude relationships based on whether each of the eight chosen neighbor's differences relative to the target R pixel exceeds the threshold.

Specifically, the first defect detection unit 66 selects one of the fifteen maps (a) to (o) that matches the defect map relative to the target R pixel explained above and outputs the corresponding number for that map to the defect map determination unit 68 as the information regarding the first defect map.

One pixel is arranged between the target pixel and the neighboring same-color pixel with the target pixel. The color of the filter over the target pixel and the color of the filter over the neighboring same-color pixel with the target pixel are the same.

The fifteen maps (a) to (o) represent a subset of the defective pixel maps.

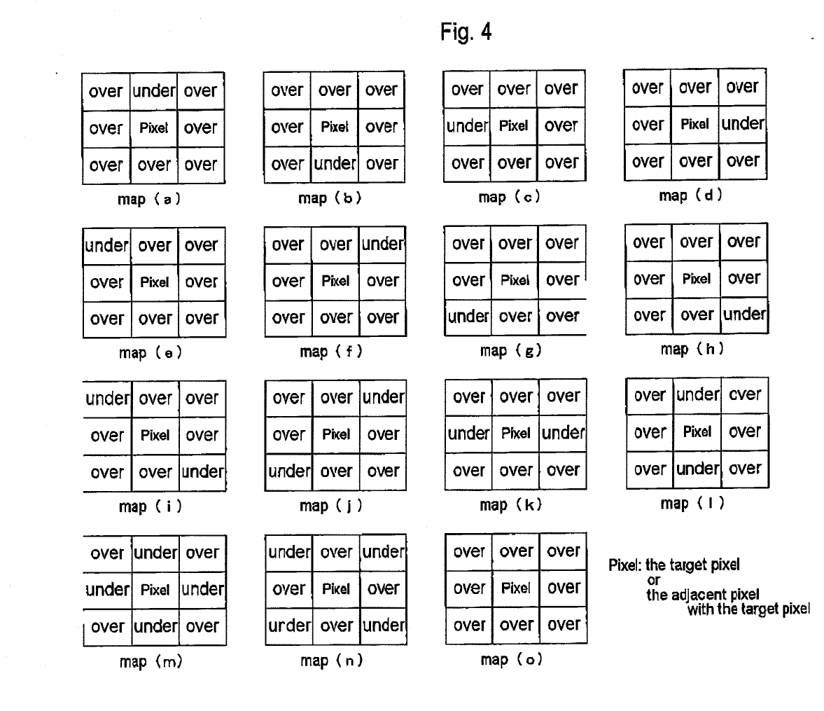

In FIGS. 4 to 7, “over” indicates the neighboring pixel whose difference of the pixel value with the pixel value of the target pixel (or adjacent pixel) exceeds the threshold, and “under” indicates that the difference does not exceed the threshold.

For example, map (a) shows the magnitude relationship where the difference between the pixel value of the target pixel (or adjacent pixel with the target pixel) and the pixel value of the upper neighboring same-color pixel does not exceed the threshold, and the other seven differences between the pixel value of the target pixel (or adjacent pixel with the target pixel) and the pixel values of the other seven neighboring same-color pixels exceed the threshold.

However, other defective pixel maps are possible; the fifteen maps (a) to (o) is not an exhaustive list.

When the map of the magnitude relationship does not match any of the fifteen maps (a) to (o), as for example, when the eight differences between the pixel value of the target pixel and the eight pixel values of the eight neighboring same-color pixels do not exceed the threshold, the target pixel is not defective, and the map determination of the heterochromatic adjacent pixels described later is not performed. In this case, information indicating that none of the fifteen maps (a) to (o) match is output to the defect map determination unit 68 as the information regarding the first defect map so that the defect map determination unit 68 outputs the defect notification flag indicating that the target R pixel is not defective as the information regarding the conclusion of the determination, to the correction unit 69.

The first defect detection unit 66 also calculates eight differences between the pixel value of the adjacent G1 pixel to the right side of the target R pixel and the pixel values of the eight neighboring G1 pixels that neighbor and surround the adjacent G1 pixel.

Then, the first defect detection unit 66 determines whether each of the eight differences relative to the adjacent G1 pixel exceeds the threshold and specifies a defect map of the magnitude relationship between the eight differences and the threshold.

In other words, the first defect detection unit 66 creates the defect map of magnitude relationships based on whether each of the eight chosen neighbor's differences relative to the adjacent G1 pixel exceeds the threshold.

Specifically, the first defect detection unit 66 selects one of the fifteen maps (a) to (o) that matches the defect map relative to the adjacent G1 pixel explained above and outputs the corresponding number for that map to the defect map determination unit 68 as the information regarding the second defect map.

One pixel is arranged between the adjacent pixel and the neighboring same-color pixel with the adjacent pixel. The color of the filter over the adjacent pixel and the color of the filter over the neighboring same-color pixel with the adjacent pixel are the same.

The second defeat detection unit 67 calculates eight differences between the pixel value of the adjacent G2 pixel to the lower side of the target R pixel and the pixel values of the eight neighboring G2 pixels that neighbor and surround the adjacent G2 pixel.

Then, the second defect detection unit 67 determines whether each of the eight differences relative to the adjacent G2 pixel exceeds the threshold and specifies a defect map of the magnitude relationship between the eight differences and the threshold.

In other words, the second defect detection unit 67 creates a defect map of magnitude relationships based on whether each of the eight chosen neighbor's differences relative to the adjacent G2 pixel exceeds the threshold.

Specifically, the second defect detection unit 67 selects one of the fifteen maps (a) to (o) that matches the defect map relative to the adjacent G2 pixel explained above and outputs the corresponding number for that map to the defect map determination unit 68 as the information regarding the third defect map.

The second defect detection unit 67 also calculates eight differences between the pixel value of the adjacent B pixel to the lower-right side of the target R pixel and the pixel values of the eight neighboring B pixels that neighbor and surround the adjacent B pixel.

Then, the second defect detection unit 67 determines whether each of the eight differences relative to the adjacent B pixel exceeds the threshold and specifies a defect map of the magnitude relationship between the eight differences and the threshold.

In other words, the second defect detection unit 67 creates a defect map of magnitude relationships based on whether each of the eight chosen neighbor's differences relative to the adjacent B pixel exceeds the threshold.

Specifically, the second defect detection unit 67 selects one of the fifteen maps (a) to (o) that matches the defect map relative to the adjacent B pixel explained above and outputs the corresponding number for that map to the defect map determination unit 68 as the information regarding the fourth defect map.

The defect map determination unit 68 determines whether the target pixel is defective or not, on the basis of the combination of the contents of the first, second, third, and fourth defect maps output from the first and second defect detection units 66 and 67. The defect map determination unit 68 also determines whether the defective pixel is a point-defective pixel or a line-defective pixel.

The defect map determination unit 68 outputs a defect notification flag as the information regarding the conclusion of the determination, to the correction unit 69.

The combinations of the contents of the first, second, third, and fourth defect maps in the case that the target pixel is not determined to be defective, are preliminarily stored in the defect map determination unit 68 or a memory (not depicted).

The combinations of the contents of the first, second, third, and fourth defect maps in the case that the target pixel is determined to be a point-defective pixel, are preliminarily stored in the defect map determination unit 68 or the memory.

Similarly, the combinations of the contents of the first, second, third, and fourth defect maps in the case that the target pixel is determined to be a line-defective pixel, are preliminarily stored in the defect map determination unit 68 or the memory.

As an example, one of the R pixels corresponding to the pixel data of the third line is set to be the target pixel, so that the adjacent G1 pixel to the right side of the target R pixel, the adjacent B pixel to the lower-right side of the target R pixel, and the adjacent G2 pixel to the lower side of the target R pixel are designated the heterochromatic adjacent pixels.

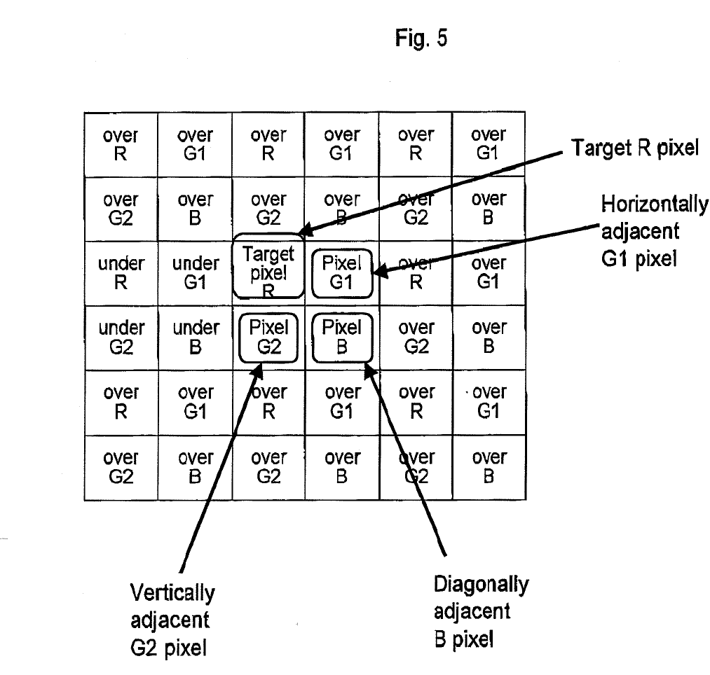

When the first, second, third, and fourth defect maps match the map (c), this means that the locations of the R, G1, G2, and B pixels not exceeding the threshold, are concentrated at the loft side of the target R pixel (see FIG. 5).

In this case, it is determined that the target R pixel is not defective and the defect map determination unit 68 outputs the defect notification flag indicating that the target R pixel is not defective as the information regarding the conclusion of the determination, to the correction unit 69.

In this manner, when the contents of the first, second, third, and fourth defect maps are the same, it is determined that the target pixel is not detective.

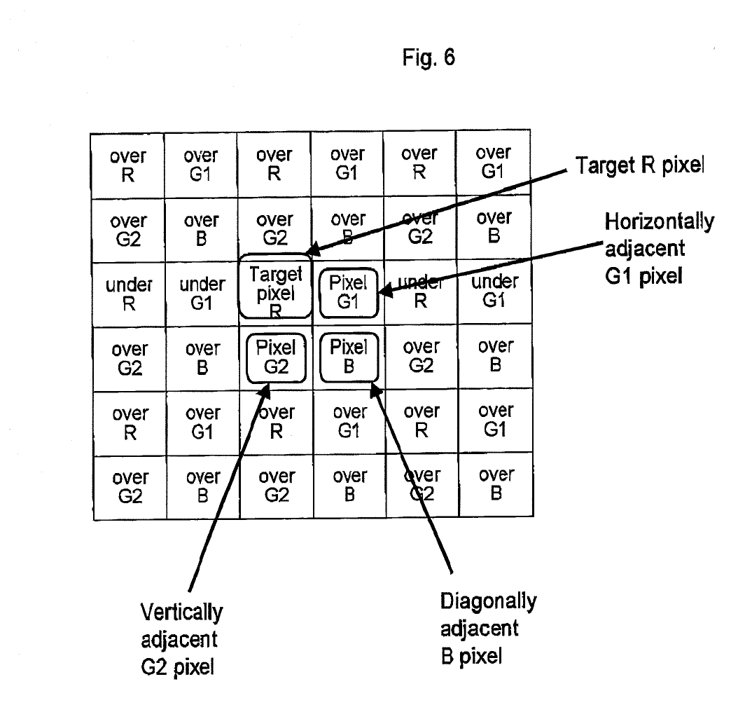

When the first and second defect maps match the map (k) and the third and fourth defect maps match the map (o), the two R pixels not exceeding the threshold and the two G1 pixels not exceeding the threshold form a horizontal line (see FIG. 6).

In this case, it is determined that the target R pixel and the adjacent G1 pixel are line-defective pixels and the defect map determination unit 68 outputs the defect notification flag indicating that the target R pixel and the adjacent G1 pixel are line-defective pixels as the information regarding the conclusion of the determination, to the correction unit 69.

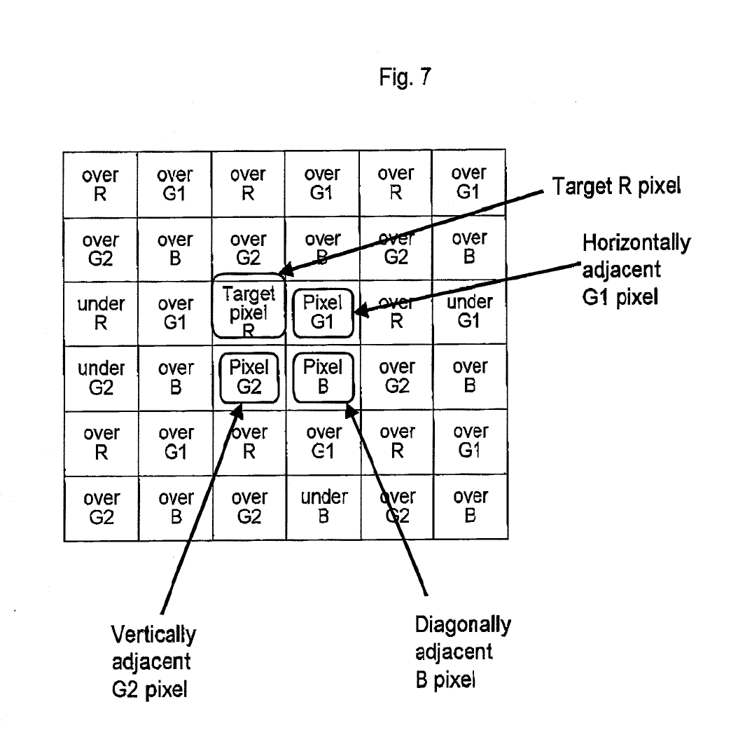

When the first and third defect maps match the map (c), the second defect map matches the map (b), and the fourth defect map matches the map (d), this means there is no concentration in the locations of: 1.) the R pixel not exceeding the threshold, 2.) the G1 pixel not exceeding the threshold, 3.) the G2 pixel not exceeding the threshold, and 4.) the B pixel not exceeding the threshold (see FIG. 7).

In this case, it is determined that the target R pixel is a point-defective pixel and the defect map determination unit 68 outputs the defect notification flag indicating that the target R pixel is a point-defective pixel as the information regarding the conclusion of the determination, to the correction unit 69.

The correction unit 69 corrects the defective pixel on the basis of the defect notification flag output from the defect map determination unit 68.

The image-processing operation of the pixel data after the defect correction by the correction unit 69 is performed by the image-processing unit 40 for presentation on the display 70 or for storage in the external storage device 80.

Furthermore, after the defect correction by the correction unit 69, the pixel data or the third line is stored in the fourth line memory 64 for subsequent use in correcting any defective pixels on the next reading line.

In the embodiment, a defective pixel is detected on the basis of: 1.) the first defeat map that gives the relationship between the pixel value of the target pixel and the pixel values of the eight neighboring same-color pixels, 2.) the second defect map that gives the relationship between the pixel value of the horizontally adjacent pixel and the pixel values of the eight neighboring same-color pixels, 3.) the third defect map that gives the relationship between the pixel value of the vertically adjacent pixel and the pixel values of the eight neighboring same-color pixels, and 4.) the fourth defect map that gives the relationship between the pixel value of the diagonally adjacent pixel and the pixel values of the eight neighboring same-color pixels.

Therefore, the complicating circuit that generates a complementary color signal of the pixel data that shows the pixel values of the cyan etc., in order to detect the defective pixel, is not necessary.

Furthermore, the defective pixels can be detected on the basis of the pixel data obtained in the image-processing operation. Thus, the pixels that became defective due to age can be detected and can be corrected.

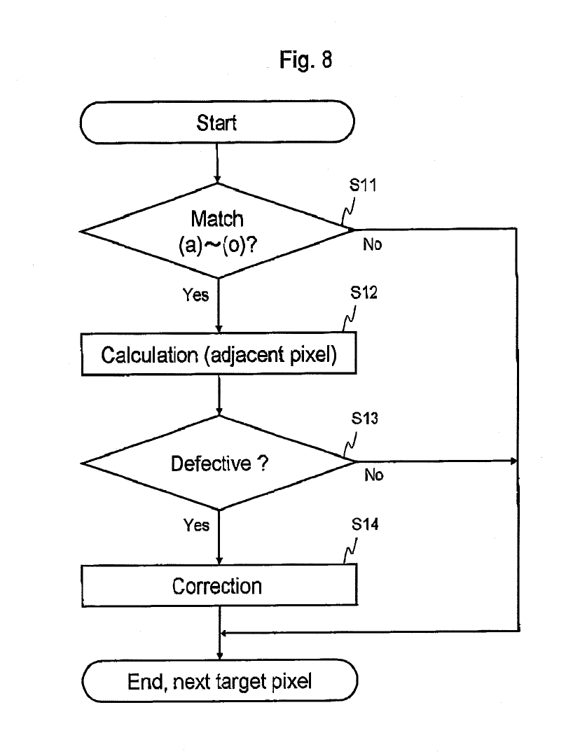

Next, the process of the determination of the defective pixel for one target pixel is explained using the flowchart of FIG. 8.

In step S11, it is determined whether the defect map of the magnitude relationship corresponding to the target pixel matches one of the fifteen maps (a) to (o).

When it is determined that the defect map of the magnitude relationship corresponding to the target pixel does not match any of the fifteen maps (a) to (o), it is deemed that the target pixel is not defective. Then, the information representing this match failure is output to the defect map determination unit 68 as the information regarding the first defect map so that the defect map determination unit 68 outputs the defect notification flag indicating that the target pixel is not defective as the information regarding the conclusion of the determination, to the correction unit 69. In this case, the operation is finished without performing the defect correction operation so that the determination of defectiveness is performed for the next target pixel.

When it is determined that the defeat map of the magnitude relationship corresponding to the target pixel matches one of the fifteen maps (a) to (o), the operation continues to step S12.

In step S12, the selected number of the fifteen maps (a) to (o) is output from the first defect detection unit 66 to the defect map determination unit 68 as the information regarding the first defect map.

Then, the first defect detection unit 66 selects one of the fifteen maps (a) to (o) that matches the magnitude relationship between the eight differences relative to the horizontally adjacent pixel and the threshold, and then the selected number is output to the defect map determination unit 68 as the information regarding the second defect map.

Similarly, the second defect detection unit 67 selects one of the fifteen maps (a) to (o) that matches the magnitude relationship between the eight differences relative to the vertically adjacent pixel and the threshold, and then the selected number is output to the defeat map determination unit 68 as the information regarding the third defect map.

Furthermore, the second defect detection unit 67 selects one of the fifteen maps (a) to (o) that matches the magnitude relationship between the eight differences relative to the diagonally adjacent pixel and the threshold, and then the selected number is output to the defect map determination unit 68 as the information regarding the fourth defect map.

In step S13, it is determined whether the target pixel is defective or not, on the basis the combination of the contents or the first, second, third, and fourth defect maps output from the first and second defect detection units 66 and 67, by the defect map determination unit 68. When it is determined that the target pixel is defective, the defeat map determination unit 68 outputs the defect notification flag indicating that the target pixel is a point- or line-defective pixel as the information regarding the conclusion of the determination, to the correction unit 69, and then the operation continues to step S14. Otherwise, the defect map determination unit 68 outputs the defect notification flag indicating that the target pixel is not defective as the information regarding the conclusion of the determination, to the correction unit 69. In this case, the operation is finished without performing the defect correction operation so that the determination of defectiveness is performed for the next target pixel.

In step S14, the correction unit 69 corrects the defective pixel on the basis of the defect notification flag output from the defect map determination unit 68, and then the operation is finished so that the determination of defectiveness is performed for the next target pixel.

Furthermore, in the embodiment, it is determined whether the target pixel is defective or not on the basis of the first defect map relative to the target pixel and the second, third, and fourth defect maps relative to the heterochromatic neighboring pixel. However, the defectiveness of the target pixel may be determined on the basis of the first defect map and at least one of the second, third, and fourth defect maps.

Although the embodiment of the present invention has been described herein with reference to the accompanying drawings, obviously many modifications and changes may be made by those skilled in this art without departing from the scope of the invention.

The present disclosure relates to subject matter contained in Japanese Patent Application No. 2007-120576 (filed on May 1, 2007), which is expressly incorporated herein by reference, in its entirety.

1. A photographic device comprising:
an image sensor; and
a defeat determination unit that determines whether a target pixel among the pixels of said image sensor is defective on the basis of a first defect map and at least one second defect map;
said first defect map showing a first relationship between a pixel value of said target pixel and pixel values of first neighboring same-color pixels with said target pixel that neighbor and surround said target, pixel;
said second defect map showing a second relationship between a pixel value of a heterochromatic adjacent pixel with said target pixel and pixel values of second neighboring same-color pixels with said heterochromatic adjacent pixel that neighbor and surround said heterochromatic adjacent pixel.

2. The photographic device according to claim 1, wherein said first relationship is a magnitude relationship between a threshold and differences between the pixel value of said target pixel and the pixel values of said first neighboring same-color pixels; and
said second relationship is a magnitude relationship between said threshold and differences between the pixel value of said heterochromatic; adjacent pixel and the pixel values of said second neighboring same-color pixels.

3. The photographic device according to claim 1, wherein said defect determination unit corrects said target pixel when said target pixel is determined to be defective.

4. The photographic device according to claim 1, further comprising line memories that store and transfer the pixel data output from said image sensor, ordered in series, by lines read from said image sensor;
wherein said first and second defect maps are calculated on the basis of the pixel data stored in said line memories.

5. The photographic device according to claim 1, wherein a Bayer color filter array is arranged over the pixels of said image sensor, said Bayer color filter array having R lines that include red filters and first green filters and B lines that include blue filters and second green filters, said R lines and said B lines arranged alternately;
when one of an R pixel corresponding to said red filter, a G1 pixel corresponding to said first green filter, a B pixel corresponding to said blue filter, and a G2 pixel corresponding to said second green filter becomes said target pixel, at least one of the others becomes said heterochromatic adjacent pixel.

6. The photographic device according to claim 1, wherein when the contents of said first defect map and said second defect map are the same, said defect determination unit determines that said target pixel is not defective.

7. A method of detecting a defective pixel in an image sensor, comprising the steps of:
first calculating that calculates a first defect map showing a first relationship between a pixel value of a target pixel of pixels of said image sensor and pixel values of first neighboring same-color pixels with said target pixel that neighbor and surround said target pixel;
second calculating that calculates a second defect map showing a second relationship between a pixel value of a heterochromatic adjacent pixel with said target pixel and pixel values of second neighboring same-color pixels with said heterochromatic adjacent pixel that neighbor and surround said heterochromatic adjacent pixel; and
determining that determines whether said target pixel is defective on the basis of said first defect map and said second defect map.
